(19) United States
(12) Patent Application Publication
(10) Pub. No.: US 2026/0048638 A1
(43) Pub. Date: Feb. 19, 2026

(54) SYSTEM AND METHOD FOR SIMULATING A VEHICLE CABIN HEATED OR COOLED BY A HEAT PUMP CIRCUIT Client Title: HP BOOSTER EXPERIMENTAL RIG

(71) Applicant: LITENS AUTOMOTIVE PARTNERSHIP, Woodbridge (CA)

(72) Inventors: David NAKHLA, Ancaster (CA); Kody A. ORR, Etobicoke (CA); Jeffrey LEUNG, Markham (CA); Venkata Prasad ATLURI, Novi, MI (US)

(21) Appl. No.: 19/301,815

(22) Filed: Aug. 15, 2025

Related U.S. Application Data
(60) Provisional application No. 63/683,634, filed on Aug. 15, 2024.

(51) Int. Cl. B60H 1/00; B60H 1/32

(52) U.S. Cl. CPC B60H 1/0073; B60H 1/3205

(57) ABSTRACT

A system and method for simulating a vehicle cabin heated or cooled by a heat pump circuit uses a coolant reservoir that stores coolant having a thermal mass equivalent to a predetermined thermal mass of the vehicle cabin. A first coolant loop in thermal communication with the heat pump circuit simulates heating or cooling of the vehicle cabin, and includes the coolant reservoir. A second coolant loop simulates heat loss from or heat gain to the vehicle cabin, and includes the coolant reservoir and a chiller or a heater. Coolant is conveyed simultaneously through the first and second coolant loops, with the flow rate of the coolant through the second coolant loop being controlled such that a heat loss or gain rate of the coolant due to cooling or heating by the chiller or heater is equivalent to a predetermined heat loss or gain rate of the vehicle cabin.

### CROSS-REFERENCE TO RELATED APPLICATION

This application claims the benefit of U.S. Provisional Patent Application 63/683,634, filed November Aug. 15, 2024, and titled “UPDATES TO CONTROL SYSTEM FOR HP BOOSTER AND REFRIGERANT SYSTEM”, the contents of which are incorporated herein by reference in their entirety.

### FIELD OF THE DISCLOSURE

The present disclosure relates to systems and methods for simulating vehicle cabins for heated or cooled by heat pump circuits, which may be used for testing of such heat pump circuits.

### BACKGROUND

International Patent Application Publication nos. WO 2022/087731 A1 (May 5, 2022), WO 2023/060352 A1 (Apr. 20, 2023), WO 2024/092359 A1 (May 10, 2024) and WO 2024/216384 A1 (Oct. 24, 2024), all to Litens Automotive Partnership disclose heat pump circuits that circulate a refrigerant to regulate the temperature of the vehicle cabin and that are interfaced with thermal management systems battery-powered electric vehicles. Research and development of such heat pump circuits requires testing of them under a variety of operating modes and thermal conditions. Conducting such tests using vehicle cabins of actual vehicles may be problematic. Installing heat pump circuits in multiple vehicles with different vehicle cabin configurations can be inconvenient and costly. Vehicles occupy a large amount of space in a laboratory environment. Even in a laboratory environment, control of thermodynamic conditions of vehicle cabins can be challenging. Testing of heat pump circuits at multiple ambient temperature conditions can be time-consuming, as it can take several hours for a vehicle cabin to reach a desired temperature condition before testing commences.

### SUMMARY OF THE DISCLOSURE

There remains a need in the art for systems and methods for simulating vehicle cabins heated or cooled by heat pump circuits.

In one aspect, the present disclosure relates to a method for simulating a vehicle cabin heated or cooled by a heat pump circuit, wherein the vehicle cabin has a predetermined thermal mass and a predetermined heat loss rate or heat loss rate, and wherein the heat pump circuit comprises a refrigerant loop comprising a refrigerant flow path through a heat exchanger. The method comprises storing a volume of coolant in a coolant reservoir for simulating the vehicle cabin, wherein a thermal mass of the volume of coolant is equivalent to the predetermined thermal mass of the vehicle cabin. The method comprises: circulating a refrigerant through the refrigerant loop and simultaneously circulating the coolant through a first coolant loop to simulate heating or cooling of the vehicle cabin, whereupon heat is transferred via the heat exchanger either from the refrigerant to the coolant or from the coolant to the refrigerant, and a second coolant loop to simulate heat loss from the vehicle cabin or heat gain to the vehicle cabin. The first coolant loop comprises the coolant reservoir and a coolant flow path of the heat exchanger in thermal communication with the refrigerant flow path through the heat exchanger. The second coolant loop comprises the coolant reservoir and one of a chiller that cools the coolant to simulate heat loss from the vehicle cabin and a heater that heats the coolant to simulate heat gain to the vehicle cabin. The second coolant loop is exclusive of the first coolant loop except for the coolant reservoir. The method comprises controlling a flow rate of the coolant through the second coolant loop such that a heat loss rate of the coolant due to cooling of the coolant by the chiller is equivalent to the predetermined heat loss rate of the vehicle cabin or such that a heat gain rate of the coolant due to heating by the heater is equivalent to the predetermined heat gain rate of the vehicle cabin.

In embodiments of the method, the method is for simulating the vehicle cabin heated by the heat pump circuit. The second coolant loop comprises the chiller that cools the coolant to simulate heat loss from the vehicle cabin. Controlling the flow rate of the coolant through the second coolant loop is performed such that the heat loss rate of the coolant due to cooling of the coolant by the chiller is equivalent to the predetermined heat loss rate of the vehicle cabin.

In embodiments of the method, the method is for simulating the vehicle cabin cooled by the heat pump circuit. The second coolant loop comprises the heater that heats the coolant to simulate heat gain to the vehicle cabin. Controlling the flow rate of the coolant through the second coolant loop is performed such that the heat gain rate of the coolant due to heating of the coolant by the heater is equivalent to the predetermined heat gain rate of the vehicle cabin.

In embodiments of the method, controlling the flow rate of the coolant through the second coolant loop comprises controlling a pump for conveying the coolant through the second coolant loop.

In embodiments of the method, controlling the flow rate of the coolant through the second coolant loop comprises controlling a valve in the second coolant loop.

In embodiments of the method, at least one non-transitory computer-readable medium stores the predetermined heat loss rate or heat gain rate or at least one relationship that prescribes the predetermined heat loss rate or heat gain rate. At least one processor operatively connected to the at least one non-transitory computer readable medium is used for controlling of the flow rate of the coolant through the second coolant loop by controlling a pump for conveying the coolant through the second coolant loop and/or a valve in the second coolant loop, based on the predetermined heat loss rate or heat gain rate or the at least one relationship that prescribes the predetermined heat loss rate or heat gain rate stored by the at least one non-transitory computer-readable medium. The method may further comprise measuring a temperature of the coolant in the second coolant loop. The method may further comprise, using the at least one processor, determining the predetermined heat loss rate or heat gain rate based on the at least one relationship that prescribes the predetermined heat loss rate or heat gain rate stored in the at least one non-transitory computer readable medium and based on the measured temperature of the coolant in the second coolant loop.

In embodiments of the method, the method further comprises, before circulating the refrigerant through the refrigerant loop and simultaneously circulating the coolant through the first coolant loop and the second coolant loop, using the cooler or the heater to regulate a temperature of the coolant in the coolant reservoir to an ambient temperature of an environment surrounding the vehicle cabin to be simulated.

In another aspect, the present disclosure relates to a system for simulating a vehicle cabin heated or cooled by a heat pump circuit, wherein the vehicle cabin has a predetermined thermal mass and a predetermined heat loss rate or heat gain rate, and wherein the heat pump circuit comprises a refrigerant loop comprising a refrigerant flow path of a heat exchanger. The system comprises a coolant reservoir, a first coolant loop, and a second coolant loop. The coolant reservoir stores a volume of coolant having a thermal mass equivalent to the predetermined thermal mass of the vehicle cabin. The first coolant loop is for simulating heating or cooling of the vehicle cabin, and comprises the coolant reservoir, a coolant flow path of the heat exchanger in thermal communication with the refrigerant flow path of the heat exchanger, and a first pump for conveying the coolant through the first coolant loop. The second coolant loop is for simulating heat loss from the vehicle cabin or heat gain to the vehicle cabin, and comprises the coolant reservoir, one of a chiller for cooling the coolant and a heater for heating the coolant, and a second pump for conveying the coolant through the second coolant loop. The second coolant loop is exclusive of the first coolant loop except for the coolant reservoir. The first pump and the second pump are operable simultaneously to convey coolant simultaneously through the first coolant loop and the second loop. The second pump is operable to convey the coolant at a flow rate through the second coolant loop such that a heat loss rate of the coolant due to cooling of the coolant by the chiller is equivalent to the predetermined heat loss rate of the vehicle cabin or such that a heat gain rate of the coolant due to heating by the heater is equivalent to the predetermined heat gain rate of the vehicle cabin.

In embodiments of the system, the system is for simulating the vehicle cabin to be heated by the heat pump circuit. The second coolant loop comprises the chiller that cools the coolant to simulate heat loss from the vehicle cabin. The second pump in the second coolant loop is operable to convey the coolant at the flow rate through the second coolant loop such that the heat loss rate of the coolant due to cooling of the coolant by the chiller is equivalent to the predetermined heat loss rate of the vehicle cabin.

In embodiments of the system, the system is for simulating the vehicle cabin to be cooled by the heat pump circuit. The second coolant loop comprises the heater that heats the coolant to simulate heat gain to the vehicle cabin. The second pump is operable to convey the coolant at the flow rate through the second coolant loop such that the heat gain rate of the coolant due to heating of the coolant by the heater is equivalent to the predetermined heat gain rate of the vehicle cabin.

In embodiments of the system, the system further comprises a valve in the second coolant loop that is operable to control the flow rate of the coolant through the second coolant loop.

In embodiments of the system, the system further comprises at least one non-transitory computer-readable medium storing the predetermined heat loss rate or heat gain rate or at least one relationship that prescribes the predetermined heat loss rate or heat gain rate. The system further comprises at least one processor operatively connected to the at least one non-transitory computer readable medium and configured by instructions stored on the at least one non-transitory computer readable medium to control the flow rate of the coolant through the second coolant loop by controlling the second pump and/or a valve in the second coolant loop, based on the predetermined heat loss rate or heat gain rate or the at least one relationship that prescribes the predetermined heat loss rate or heat gain rate stored by the at least one non-transitory computer-readable medium. The system may further comprise a temperature sensor for measuring a temperature of the coolant in the second coolant loop. The processor may be configured by the instructions stored on the at least one non-transitory computer readable medium to determine the predetermined heat loss rate or heat gain rate based on the at least one relationship that prescribes the predetermined heat loss rate or heat gain rate stored by the at least one non-transitory computer-readable medium and based the temperature of the coolant in the second coolant loop measured by the temperature sensor.

In embodiments of the system, the system further comprises a thermally insulated chamber, wherein the coolant reservoir is disposed inside the thermally insulated chamber.

### BRIEF DESCRIPTION OF THE DRAWINGS

The foregoing and other aspects of the disclosure will be better appreciated with reference to the attached drawings, as follows.

FIG. 1 is a schematic diagram of an example of a heat pump circuit used to heat air that flows into a vehicle cabin.

FIG. 2A is a chart showing an embodiment of a relationship between heat loss rate and an ambient temperature outside of a vehicle cabin, which may be used by the system of the present disclosure.

FIG. 2B is a chart showing an embodiment of a relationship between heat loss rate and a temperature differential between a temperature inside of a vehicle cabin and an ambient temperature outside of a vehicle cabin, which may be used by the system of the present disclosure.

FIG. 3 is a schematic diagram of an embodiment of a system of the present disclosure for simulating a vehicle cabin for testing the heat pump circuit of FIG. 1 for heating a vehicle cabin.

FIGS. 4A to 4D are charts showing the change, over time, in operating parameters of the heat pump circuit and the system, shown in FIG. 3, during a test of the heat pump circuit using the system to simulate different initial ambient temperatures.

FIG. 4A shows the change in compressor speed of the heat pump circuit.

FIG. 4B shows the change in temperature of coolant in the coolant reservoir of the system.

FIG. 4C shows the change in electrical power consumption of the compressor motor and the electric heater of the heat pump circuit.

FIG. 4D shows the change in total electrical power consumption of the compressor motor and the electric heater of the heat pump circuit, and the heat transferred to the coolant in the system.

FIG. 5 is a schematic diagram of an embodiment of a system of the present disclosure for simulating a vehicle cabin for testing the heat pump circuit for cooling a vehicle cabin.

### DETAILED DESCRIPTION OF EXAMPLE EMBODIMENTS

### Interpretation

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although example embodiments are illustrated in the figures and described below, the principles of the present disclosure may be implemented using any number of techniques, whether currently known or not. The present disclosure should in no way be limited to the example implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “example” should be understood as “illustrative” or “exemplifying” and not necessarily as “preferred” over other embodiments. Further definitions for terms may be set out herein; these may apply to prior and subsequent instances of those terms, as will be understood from a reading of the present description.

It will also be noted that the use of the term “a” or “an” will be understood to denote “at least one” in all instances unless explicitly stated otherwise or unless it would be understood to be obvious that it must mean “one”. The phrase “at least one of” is understood to be one or more. The phrase “at least one of . . . and . . . ” is understood to mean at least one of the elements listed or a combination thereof, if not explicitly listed. For example, “at least one of A, B, and C” is understood to mean A alone or B alone or C alone or a combination of A and B or a combination of A and C or a combination of B and C or a combination of A, B, and C.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. It will be understood that any embodiments described as “comprising” certain components may also “consist of” or “consist essentially of” these components, wherein “consisting of” has a closed-ended or restrictive meaning and “consisting essentially of” means including the components specified but excluding other components except for components added for a purpose other than achieving the technical effects described herein.

It will be understood that any component defined herein as being included may be explicitly excluded from the claimed invention by way of proviso or negative limitation, such as any specific components or method steps, whether implicitly or explicitly defined herein.

In addition, all ranges given herein include the end of the ranges and also any intermediate range points, whether explicitly stated or not.

Terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.” The word “or” is intended to include “and” unless the context clearly indicates otherwise.

“Attached”, as used herein, in describing the relationship between two connected parts includes the case in which the two connected parts are “directly attached” with the two connected parts being in contact with each other, and the case in which the connected parts are “indirectly attached” and not in contact with each other but connected by one or more intervening other part(s) between.

Any reference to upper, lower, top, bottom or the like is intended to refer to an orientation of a particular element during use of the claimed subject matter and not necessarily to its orientation during shipping or manufacture. The upper surface of an element, for example, can still be considered its upper surface even when the element is lying on its side.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The embodiments of the disclosures described herein are examples (e.g., in terms of materials, shapes, dimensions, and constructional details) and are not limited by the claims appended hereto and any amendments made thereto. Persons skilled in the art will appreciate that there are yet more alternative implementations and modifications possible, and that the following examples are only illustrations of one or more implementations. The scope of the invention, therefore, is only to be limited by the claims appended hereto and any amendments made thereto.

Unless otherwise explained, all technical and scientific terms used herein have the same meaning as commonly understood by one of ordinary skill in the art to which this disclosure belongs.

### Computer Implementation

The term “processor”, as used herein, refers to one or more electronic hardware devices that is/are capable of reading and executing instructions stored on a memory to perform operations on data, which may be stored on a memory or provided in a data signal. The term “processor” includes a single device or a plurality of physically discrete, operatively connected devices despite use of the term in the singular. The plurality of processors may be arrayed or distributed. Non-limiting examples of processors include integrated circuit semiconductor devices and/or processing circuit devices referred to as computers, servers or terminals having single or multi-processor architectures, microprocessors, microcontrollers, microcontroller units (MCU), central processing units (CPU), field-programmable gate arrays (FPGA), application specific circuits (ASIC), digital signal processors, and combinations of the foregoing

The term “memory”, as used herein, refers to a non-transitory tangible computer-readable medium for storing information (e.g., data or data structures) in a format readable by a processor, and/or instructions (e.g., computer code or software programs or modules) that are readable and executable by a processor to implement an algorithm. The term “memory” includes a single device or a plurality of physically discrete, operatively connected devices despite use of the term in the singular. Non-limiting types of memory include solid-state semiconductor, optical, magnetic, and magneto-optical computer readable media. Examples of memory technologies include optical discs such as compact discs (CD-ROMs) and digital versatile (or video) discs (DVDs), magnetic media such as floppy disks, magnetic tapes or cassettes, and solid state semiconductor random access memory (RAM) devices, read-only memory (ROM) devices, electrically erasable programmable read-only memory (EEPROM) devices, flash memory devices, memory chips and combinations of the foregoing. Memory may be non-volatile or volatile. Memory may be physically attached to a processor, or remote from a processor. Memory may be removable or non-removable from a system including a processor. Memory may be operatively connected to a processor in such a way as to be accessible by a processor. Instructions stored by a memory may be based on a plurality of programming and/or markup languages known in the art, with non-limiting examples including the C, C++, C#, Python™, MATLAB™, Java™, JavaScript™, Perl™, PHP™, SQL™, Visual Basic™, Hypertext Markup Language (HTML), Extensible Markup Language (XML), and combinations of the foregoing programming languages. Instructions stored by a memory may also be implemented by configuration settings for a fixed-function device, gate array or programmable logic device.

Any method, application or module herein described may be implemented using computer readable/executable instructions that may be stored or otherwise held by a memory and executed by a processor. Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, such that the processor, and a memory storing the instructions, which execute via the processor, collectively constitute a machine for implementing the functions/acts specified in the flowchart and/or block diagram block or blocks.

The flowcharts and functional block diagrams in the figures, if present, illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### Heat Pump Circuit for Heating a Vehicle Cabin

The term “vehicle cabin”, as used herein, refers to the interior portion of a vehicle which can be occupied by a driver or passenger. The vehicle may be an automobile or another type of vehicle.

The term “heat pump circuit”, as used herein, refers to a refrigerant loop for circulating a refrigerant, wherein the refrigerant loop comprises a refrigerant flow path through a heat exchanger to provide either heating duty or cooling duty to a fluid flowing through a fluid flow path of the heat exchanger in thermal communication with the refrigerant flow path. Thus, a heat pump circuit may be used either as a heater for heating the fluid, or as a cooler (e.g., an air conditioner) for cooling the fluid. In some embodiments, a heat pump circuit has components operable to change the refrigerant, cyclically, between a liquid phase and a gas phase, to cyclically absorb heat from a heat source and reject heat to a heat sink. For example, in embodiments where the heat pump circuit is used as a heater for the fluid, such components may comprise in the following sequence: a compressor for increasing the pressure and temperature of the refrigerant, a first heat exchanger for transferring heat from the refrigerant to the fluid, an expansion valve for decreasing the pressure and temperature of the refrigerant, and a heat source for heating the refrigerant. In such embodiments, the heat source for heating the refrigerant may comprise either a second heat exchanger for transferring heat from a second fluid to the refrigerant, or an electric heater for heating the refrigerant, or both the second heat exchanger and the electric heater. In embodiments where the heat source comprises the second heat exchanger, the first fluid and the second fluid may be the same type of fluid; for example, both the first and second fluid may be air. Alternatively, the first fluid and the second fluid may be different fluids; for the example, the first fluid may be air, and the second fluid may be a coolant.

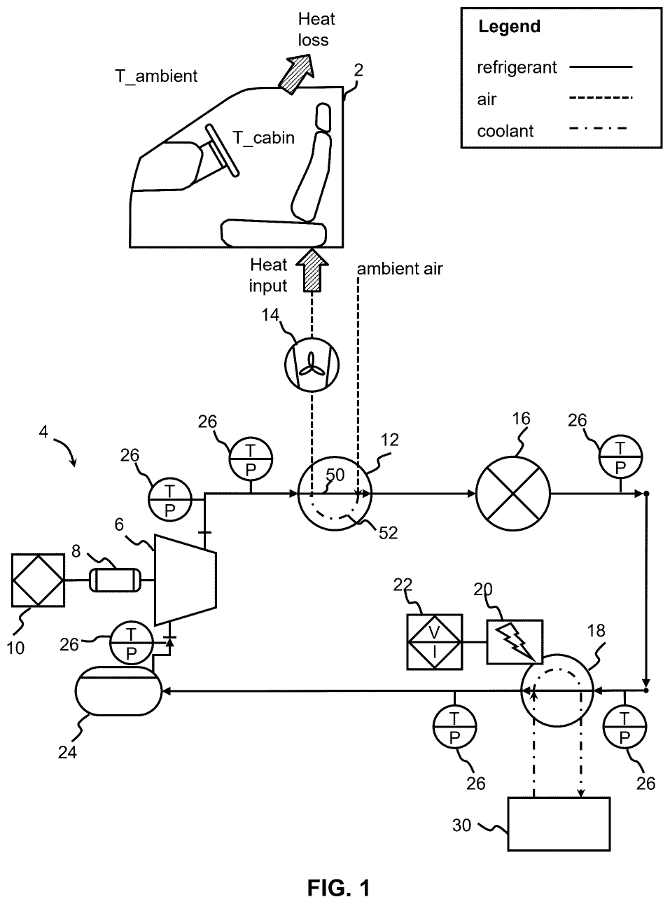

FIG. 1 is a schematic diagram of an example heat pump circuit 4 used to heat ambient air that flows into a vehicle cabin 2 of an electric vehicle. The interior of the vehicle cabin 2 is at a temperature denoted “T_cabin”, while the surrounding environment outside of the vehicle cabin is at a temperature denoted “T_ambient”. In this example, the heat pump circuit 4 is used to heat the interior of the vehicle cabin 2 to a value of T_cabin (e.g., +20 to +23 degrees Celsius) that is higher than the value of T_ambient (e.g., −20 to −10 degrees Celsius), as denoted by the arrow labeled “heat input”. As a result of this temperature differential, heat is lost from the vehicle cabin 2 to the ambient environment, as denoted by the arrow labelled “heat loss”. This heat loss may be due to a combination of phenomenon including convective losses (e.g., through window glazing of the vehicle cabin 2), which may depend on factors including the speed of the vehicle, and ventilation losses, which may depend on factors including the flow rate at which relatively cooler fresh air is introduced into the vehicle cabin 2 in comparison to the flow rate at which air is recycled to the vehicle cabin 2 by the HVAC system of the vehicle.

It will be understood that the vehicle cabin 2 has a predetermined thermal mass. The term “thermal mass”, as used herein, refers to the amount of thermal energy required to be added to an object and/or space (e.g., the materials and air inside the vehicle cabin 2) to cause an increase in temperature of the object and/or space by one unit of temperature. For example, thermal mass may have units of Joules per degree Celsius, and may be expressed by the equation, C=Q/dT, where C is the thermal mass of the object or space, Q is the amount of thermal energy added to the object or space, and dT is the change in temperature. The thermal mass of the vehicle cabin 2 may be predetermined by empirical study or may be estimated. The thermal mass of the vehicle cabin 2 may be affected by factors such as the size of the vehicle cabin 2 and thus, the volume of air contained therein, and the materials of the vehicle cabin 2.

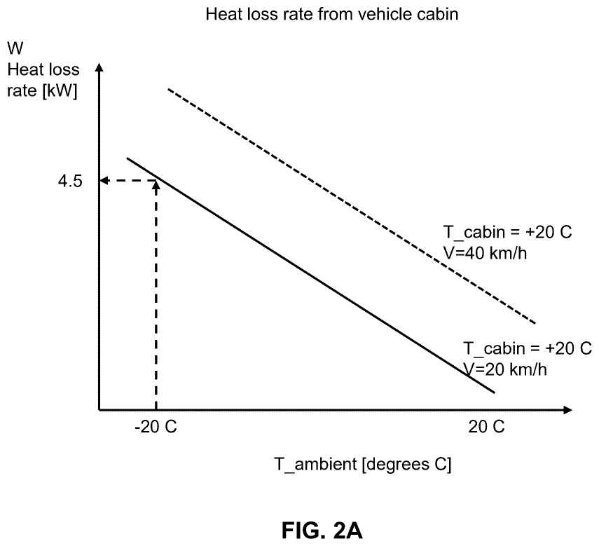

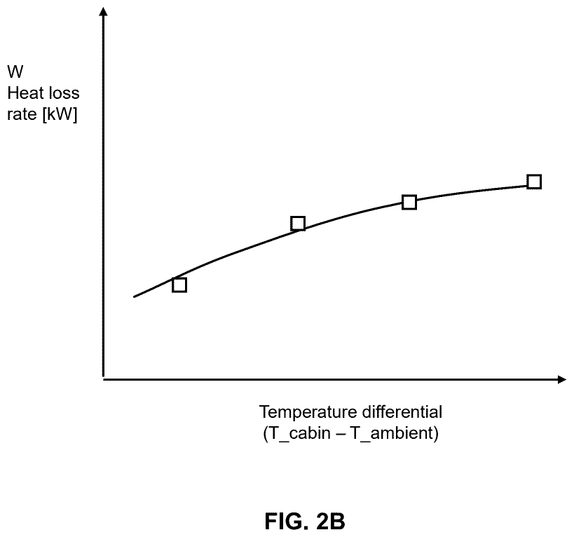

Further, it will be understood that the vehicle cabin 2 has a predetermined “heat loss rate” or “heat gain rate”. The terms “heat loss rate” and “heat gain rate”, as used herein, refers to the amount of thermal energy that is lost or gained per unit of time by an object or space (e.g., the vehicle cabin 2). For example, the heat loss rate or heat loss gain of an object or space may have units of energy per unit time (e.g., Joules per second or its equivalent, Watt). For example, the heat loss rate or heat gain rate due to convective heat transfer from or to the vehicle cabin 2 may be modelled by the equation W=h×A×(T_cabin−T_ambient), where W is the heat loss rate or the heat gain rate, h is a heat transfer coefficient (e.g., expressed in units of energy per unit time, per unit area, per unit of temperature), which may be a function of factors such as the geometry and speed of the vehicle cabin 2, and A is a heat transfer surface area from which heat may be lost or gained (e.g., through window glazing of the vehicle cabin 2). A relationship between heat loss rate or heat gain rate of the vehicle cabin 2 and a temperature differential between the temperature inside the vehicle cabin and a temperature outside of the vehicle cabin, over a range of temperature differentials, may be predetermined by empirical study, or may be estimated. For example, FIG. 2A is a chart showing an embodiment of a relationship between heat loss rate, W, for a vehicle cabin and the temperature, T_ambient, inside the vehicle cabin 2, assuming that the temperature, T_cabin, inside the vehicle cabin 2 is +20 degrees Celsius. The heat loss rate, W, depends on the speed of the vehicle, and thus FIG. 2A shows first and second relationships for the vehicle traveling at 20 km/h and 40 km/h respectively. As another example, FIG. 2B is a chart showing an embodiment of a relationship between heat loss rate, W, and a temperature differential between the temperature, T_cabin, inside the vehicle cabin 2 and a temperature, T_ambient, outside of the vehicle cabin 2. In this embodiment, the relationship (shown by the solid line) is a non-linear relation that is fit to empirical data (shown by datapoints), and thus deviates from an idealized linear relationship. Persons skilled in the art will appreciate that the foregoing are non-limiting embodiments of relationships describing the heat loss rate, which will be particular to a specific vehicle cabin and the operating condition of the vehicle. Such relationships may be predetermined by testing or simulation.

Referring to FIG. 1, in this embodiment, the heat pump circuit 4 includes a refrigerant loop that includes, in the following order, a compressor 6, a first heat exchanger 12, an expansion valve 16, a second heat exchanger 18 with an electric heater 20, and an accumulator 24. The refrigerant may have a composition used in air conditioning systems such as a hydrofluoroolefin refrigerant (e.g., R-1234yf) or propane refrigerant (e.g., R-290). The operation of the heat pump circuit 4 is as follows.

The compressor 6 is powered by an electric compressor motor 8. The refrigerant can enter the compressor 6 in a gas phase at a relatively low pressure, and a relatively low temperature. The compressor 6 compresses the refrigerant, to bring the refrigerant to a high pressure, which raises its temperature. As a result, the refrigerant is a high pressure, high temperature gas when leaving a discharge port of the compressor 6. A compressor controller 10 controls the speed of the compressor motor 8 of the compressor 6, and thus the degree to which the compressor 6 increases the temperature and pressure of the refrigerant. The compressor controller 10 may comprise a processor and a non-transitory computer-readable medium storing program instructions executable by the processor to generate control signals for the compressor motor 8 in response to inputs by a user and/or in accordance with the instructions.

The refrigerant then passes to the first heat exchanger 12, which can act as a condenser and is used to condense the refrigerant, by carrying out heat transfer from the refrigerant flowing therethrough to the ambient air that surrounds the first heat exchanger 12, thereby heating the ambient air. The ambient air may be air that is freshly drawn into the heating ventilation and air conditioning (HVAC) system of the vehicle and/or air that is recirculated from the vehicle cabin 2 by the HVAC system of the vehicle. A blower fan 14 enhances air flow across the first heat exchanger 12, and therefore enhances heat transfer from the refrigerant to the ambient air. The heated ambient air flows into the vehicle cabin 2 via ducting of the HVAC system and thus heats the vehicle cabin 2. The temperature of the ambient air is lower than that of the refrigerant, and so the refrigerant condenses in the first heat exchanger 12, and leaves the first heat exchanger 12 as a liquid.

The liquid refrigerant then passes through the expansion valve 16, so as to reduce the pressure of the refrigerant. Some of the refrigerant may evaporate due to the reduction in pressure, however, a significant portion of the refrigerant remains liquid. The reduction in pressure of the refrigerant cools the refrigerant. Thus, the refrigerant leaves the expansion valve 16 as a low pressure, low temperature mixture of liquid and gas.

The refrigerant then passes through the second heat exchanger 18. The second heat exchanger 18 can act as an evaporator and can transfer heat from a coolant to the refrigerant, in order to raise the temperature of the refrigerant so as to drive the evaporation of the refrigerant. The coolant that flows through the second heat exchanger 18 may circulate in a thermal management system 30 to regulate the temperature of a battery pack (not shown) and/or other electrical loads of the electric vehicle, and as such may have a higher temperature than the temperature of the refrigerant.

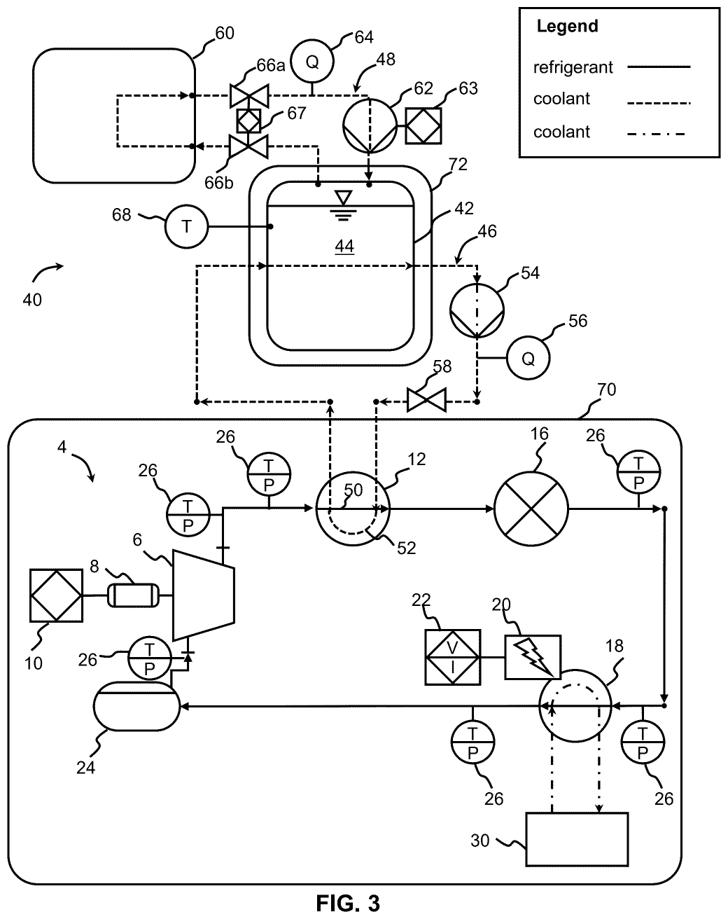

In this embodiment, the heat pump circuit 4 includes an electric heater 20. As an example, when the heat pump circuit 4 is used for heating a vehicle cabin (such as discussed below with reference to FIG. 3), and/or when it is desirable to heat the battery pack of the electric vehicle to a desired operating temperature range, the electric heater 20 can be energized to supply heat to the refrigerant, and any coolant, as it flows or they flow through the second heat exchanger 18. The electric heater 20 may be in the form of a film heater attached to the second heat exchanger 18. A heater controller 22 controls the electrical power supplied to the electric heater 20 (e.g., by controlling current and/or voltage of the electrical power) and thus the amount of heat generated by the electric heater 20. The heater controller 22 may comprise a processor and a non-transitory computer-readable medium storing instructions executable by the processor to vary electrical power to the electric heater 20 in response to inputs by a user and/or in accordance with the instructions. Although FIG. 1 shows the heater controller 22 as physically discrete from the compressor controller 10, they may share a common processor and/or non-transitory computer readable medium.

In other embodiments, not shown, the heat pump circuit 4 may omit the electric heater 20, such that the heat pump circuit 4 has only the second heat exchanger 18 to act as the heat source for vaporizing the refrigerant. In still other embodiments, not shown, the heat pump circuit 4 may omit the second heat exchanger 18, such that the heat pump circuit 4 may have only the electric heater 20 applied to the flow path of the refrigerant so as to act as the heat source for vaporizing the refrigerant. Alternatively, in some operating modes of the heat pump circuit 4, the electric heater 20 may be operated while the flow path for coolant from the thermal management system 30 to the second heat exchanger 18 is closed so that such coolant does not flow through the second heat exchanger 18.

In the embodiment shown in Figure, an accumulator 24 may be located downstream of the second heat exchanger 18 and upstream of the suction port of the compressor 6 stores any refrigerant in the liquid phase and prevents any refrigerant in the liquid phase from flowing to the suction port of the compressor 6, while allowing refrigerant in the gas phase to flow to the suction port of the compressor 6. As will be appreciated by persons skilled in the art, some refrigerant may be present in the liquid phase for a variety of reasons, such as inefficacy of the second heat exchanger 18 to completely vaporize the refrigerant in certain operating conditions and/or variation in refrigerant demand by the compressor 6 during its operation, which may result in some of the vaporized refrigerant re-condensing into the liquid phase. The refrigerant in the gas phase passes to the suction port of the compressor 6, where it is compressed again in a continuous cycle. In other embodiments, the heat pump circuit 4 may omit the accumulator 24.

In the embodiment shown in FIG. 1, the heat pump circuit 4 can include a plurality of pressure and temperature sensors 26 for measuring pressure and temperature of the refrigerant at a plurality of locations of the heat pump circuit 4. The pressure sensors may be implemented by any suitable type of fluid pressure sensor such as an electronic pressure sensor (e.g., a piezoresistive pressure sensor), as known in the art. The temperature sensors may be implemented by any suitable type of fluid temperature sensor such as an electronic temperature sensor (e.g., a thermocouple sensor), as known in the art.

In operation, the heat pump circuit 4 is used to heat ambient air that flows into the vehicle cabin 2. There will be some lost heat from the vehicle cabin 2 because the vehicle cabin 2 is not a thermodynamically closed system. Due to this lost heat, if the temperature of the ambient environment around the vehicle cabin 2 is constant, and the heat pump circuit 4 is operated in a steady-state (e.g., the speed of the compressor motor 8 is constant and the electrical power supplied by the heater 20 is constant), then the temperature of the vehicle cabin 2 may reach a steady-state temperature rather than increasing indefinitely.

### System for Simulating Vehicle Cabin for Testing a Heat Pump Circuit for Heating a Vehicle Cabin

FIG. 3 is a schematic diagram of an embodiment of a system 40 of the present disclosure for simulating a vehicle cabin 2 shown in FIG. 1, for testing the heat pump circuit 4 shown in FIG. 1 for heating the vehicle cabin 2.

In the embodiment shown in FIG. 3, the system 40 for simulating a vehicle cabin 2 includes a coolant reservoir 42, a first coolant loop 46, a second coolant loop 48, and other components as described below.

The coolant reservoir 42 stores a volume of coolant 44. The term “coolant”, as used herein, is not limited to any particular composition of fluid. As non-limiting examples, coolant may comprise water and/or ethylene glycol. The coolant may be selected such that it remains in a liquid phase over an expected temperature range in which the system 40 is to be operated for testing of the heat pump circuit 4.

The volume of coolant 44 stored by the coolant reservoir 42 is selected so that it has a thermal mass equivalent to the thermal mass of the vehicle cabin 2 to be simulated. (For this purpose, it is assumed that the conduits of the cooling first coolant loop 46 and the second coolant loop 48 are empty of coolant, or that they contain a volume of coolant contained that is negligibly small in comparison to the volume of coolant 44 stored by the coolant reservoir 42). For example, the volume of coolant 44 required may be determined by dividing the thermal mass of the vehicle cabin 2 by the specific heat capacity of the coolant and by the mass density of the coolant within the expected temperature in which the system 40 is to be operated. In this manner, the volume of coolant 44 is used to thermodynamically simulate the vehicle cabin 2.

From the above description of the heat pump circuit 4, it will be understood that the first heat exchanger 12 includes a first flow path, referred to herein as a refrigerant flow path 50 for flow of refrigerant through the first heat exchanger 12, and a second flow path that is normally used for flow of air through the first heat exchanger 12, with the first flow path and the second flow path being in thermal communication with each other. In the context of the system 40, the second flow path of the first heat exchanger 12 is used for flow of the coolant through the first heat exchanger 12, and is therefore referred to herein as the coolant flow path 52.

A purpose of the first coolant loop 46 is to simulate the transfer of heat between the heat pump circuit 4 and the vehicle cabin 2. The first coolant loop 46 includes the coolant reservoir 42, the coolant flow path 52 of the first heat exchanger 12, and a first pump 54 for conveying flow of the coolant through the first coolant loop 46. Although FIG. 3 shows the first pump 54 downstream of the coolant reservoir 42 and upstream of the coolant flow path 52, the first pump 54 may have a different location relative to these components.

A purpose of the second coolant loop is to simulate the transfer of heat between the vehicle cabin 2 and the ambient environment, e.g., due to heat loss from the vehicle cabin 2 when the temperature T_cabin is higher than the temperature, T_ambient, or due to heat gain to the vehicle cabin 2 when the temperature T_cabin is lower than the temperature, T_ambient. The second coolant loop 48 includes the coolant reservoir 42, a chiller 60 for cooling the coolant, and a second pump 62 for conveying the coolant through the second coolant loop 48. The second coolant loop 48 is exclusive of the first coolant loop 46 except for the coolant reservoir 42. The chiller 60 may be implemented by any suitable type of chiller device that applies a cooling duty to the coolant in the second coolant loop 48 such as a chiller that operates by a vapor-compression refrigeration cycle, as known in the art. The chiller 60 may be selected so that it is capable of cooling the coolant as it exits the chiller 60 to a temperature of the ambient environment in which the heat pump circuit 4 is to be operated (e.g., as low as −20 degrees Celsius, or −40 degrees Celsius). Although FIG. 3 shows the second pump 62 downstream of the chiller 60 and upstream of the coolant reservoir 42, the second pump 62 may have a different location relative to these components.

In the embodiment shown in FIG. 3, the first coolant loop 46 can also include a flow meter 56 for measuring a flow rate of coolant through the first coolant loop 46, and the second coolant loop 48 can include a flow meter 64 for measuring a flow rate of coolant through the first coolant loop 46. The flow meters 56 and 64 may be implemented by any suitable type of flow meter such as an electronic flow meter (e.g., an electromagnetic flow meter or an ultrasonic flow meter), as known in the art.

In the embodiment shown in FIG. 3, the first coolant loop 46 can include a valve 58 for regulating the flow of coolant in the first coolant loop 46, and the second coolant loop 48 can also include at least one valve (in this embodiment, a pair of valves 66a, 66b) for regulating the flow of coolant in the second coolant loop 48. In embodiments, the valves 58, 66a, 66b may be implemented by any suitable type of valve such as a solenoid valve that may be controlled by a control signal from a processor, as known in the art. In the embodiment shown in FIG. 3, the system 40 can also include a valve controller 67 for controlling a degree of opening of the at least one valve 66a, 66b and thus the flow rate of the coolant through the second coolant loop 48. The valve controller 67 may comprise a processor and a non-transitory computer-readable medium storing program instructions executable by the processor to generate control signals for the at least one valve 66a, 66b in response to inputs by a user and/or in accordance with the instructions.

In some embodiments, the first coolant loop 46 may omit the valve 58, and the flow of coolant in the first coolant loop 46 may be regulated by operation of the first pump 54 (e.g., by controlling its speed). In some embodiments, the second coolant loop 48 may omit the at least one valve 66a, 66b, and the flow of coolant in the second coolant loop 48 may be regulated by operation of the second pump 62 (e.g., by controlling its speed). In embodiments, the first pump 54 and the second pump 62 may be implemented by any suitable type of pump with a motor that may be controlled by a control signal from a processor, as known in the art. In the embodiment shown in FIG. 3, the system 40 can also include a pump controller 63 for controlling the speed of the second pump 62, and thus the flow rate of the coolant through the second coolant loop 48. The pump controller 63 may comprise a processor and a non-transitory computer-readable medium storing program instructions executable by the processor to generate control signals for the second pump 62 in response to inputs by a user and/or in accordance with the instructions. Although FIG. 3 shows the valve controller 67 as physically discrete from the pump controller 63, they may share a common processor and/or non-transitory computer readable medium, and be referred to individually or collectively as a controller.

In the embodiment shown in FIG. 3, the system 40 can also include a temperature sensor 68 for measuring a temperature of the volume of coolant 44 in the coolant reservoir 42, or more generally, at another location of the second coolant loop 48 where the temperature of the coolant is representative of the temperature of the coolant in the coolant reservoir 42. For instance, assuming that the coolant in the coolant reservoir 42 is fully mixed (i.e., there are no temperature gradients inside the coolant reservoir 42), then in this case the temperature of coolant at the inlet of the chiller 60 will be equivalent to the temperature of coolant in the coolant reservoir 42, which is used to simulate the temperature of the vehicle cabin. The temperature sensor 68 may be implemented by any suitable type of fluid temperature sensor such as an electronic temperature sensor (e.g., a thermocouple sensor), as known in the art.

In the embodiment shown in FIG. 3, the system 40 can also include a first thermally insulated chamber 70 that contains the heat pump circuit 4, and a second thermally insulated chamber 72 that contains the coolant reservoir 42. In other embodiments, a single insulated chamber may contain both the heat pump circuit 4 and the coolant reservoir 42. The thermally insulated chambers 70, 72 may be cooled so that the environment surrounding the heat pump circuit 4 and the coolant reservoir 42 is at temperature of an ambient environment of the vehicle cabin 2 to be simulated. For example, the interior of the thermally insulated chambers 70, 72 may be cooled to a temperature of −20 degrees Celsius to simulate winter conditions.

In use and operation of the system 40, the first pump 54 of the first coolant loop 46 and the second pump 62 of the second coolant loop 48 are used to convey coolant simultaneously through the first coolant loop 46 and the second loop 48, respectively, while refrigerant flows through the refrigerant loop of the heat pump circuit 4 while operating the compressor 6. Further, the first pump 54 of the first coolant loop 46 and the second pump 62 of the second coolant loop 48 can be operable independently of each other, such that the flow rate of the coolant through the first coolant loop 46 and the flow rate of the coolant through the second coolant loop 48 may be controlled independently of each other.

In use and operation of the system 40, the flow of coolant through the first coolant loop 46 is used to simulate the exposure of ambient air (i.e., the air that flows to the vehicle cabin 2) to the heating duty of the refrigerant that flows through the refrigerant flow path 50 of the first heat exchanger 12. Thus, the first pump 54 may be operated to effect a flow rate of the coolant through the coolant flow path 52 of the first heat exchanger 12 that is thermodynamically equivalent to the flow of the ambient air through the coolant flow path 52 when the heat pump circuit 4 is used to heat the vehicle cabin 2, having regard to the difference between the specific heat capacities of the coolant and air.

In use and operation of the system 40, the flow of coolant through the second coolant loop 48 is used to simulate heat loss from the vehicle cabin 2. Thus, the speed of the second pump 62 and/or the opening size of the at least one valve (in this embodiment, the pair of valves 66a, 66b) may be selected to effect a flow rate of the coolant through the chiller 60 such that a heat loss rate due to cooling of the coolant by the chiller 60 is equivalent to the heat loss rate of the vehicle cabin 2. This is further described with reference to the below example.

### Example of Testing of Heat Pump Circuit

Table I below summarizes parameters of a non-limiting example of the system 40 described above with reference to FIG. 3.

TABLE I

| Parameter | Value | |
|---|---|---|
| Volume of coolant in coolant reservoir | 37.85 | liters |
| Coolant composition | 50/50 ethylene glycol | |
| | and water mixture | |
| Coolant specific heat capacity | 3.3 kJ/(kg * degree Celsius) | |
| Coolant flow rate in first coolant | ~10 | liters per minute |
| flow loop | | |
| Coolant flow rate in second coolant | ~2 | liters per minute |
| flow loop | | |
| Simulated vehicle cabin set point | +20 | degrees Celsius |
| temperature | | |

| | |
|---|---|
| Simulated ambient temperature | −10 to +25 degrees Celsius |

As noted above, the speed of the second pump 62 and/or the opening size of the at least one valve (in this embodiment, the pair of valves 66a, 66b) may be selected to effect a flow rate of the coolant through the chiller 60 of the second coolant loop 48 such that a heat loss rate due to cooling of the coolant by the chiller 60 is equivalent to the heat loss rate of the vehicle cabin 2. The determination of this flow rate is illustrated by the following example for a simulated setpoint cabin temperature, T_cabin, of +20 degrees Celsius and a simulated ambient temperature, T_ambient, of −20 degrees Celsius, using the heat loss relationship shown in FIG. 2A for a vehicle travelling at 20 km/h. The flow rate of coolant in the second coolant loop 48, Q may be expressed by the equation Q=W/[Cc×(T_cabin−T_ambient)], where W is the heat loss rate of 4.5 KW as determined from FIG. 2A for the specified conditions, Cc is the specific heat capacity of the coolant of 3.3 kJ per gram per degree Celsius in this example, T_cabin is the setpoint cabin temperature of +20 degrees Celsius, and T_ambient is the temperature of the ambient environment of −20 degrees Celsius. In this example, Q=4.5 KW/[(3.3 kJ/(kg*degrees Celsius))×(+20 degrees Celsius−(−20 degrees Celsius])=˜0.03 kg/s=˜2.0 liters per minute. By varying the flow rate, Q, of the coolant in the second coolant loop 48, the system 40 may be used to simulate different heat loss rates, W, from the vehicle cabin 2, such as for different combinations of T_cabin, T_ambient and speeds of the vehicle.

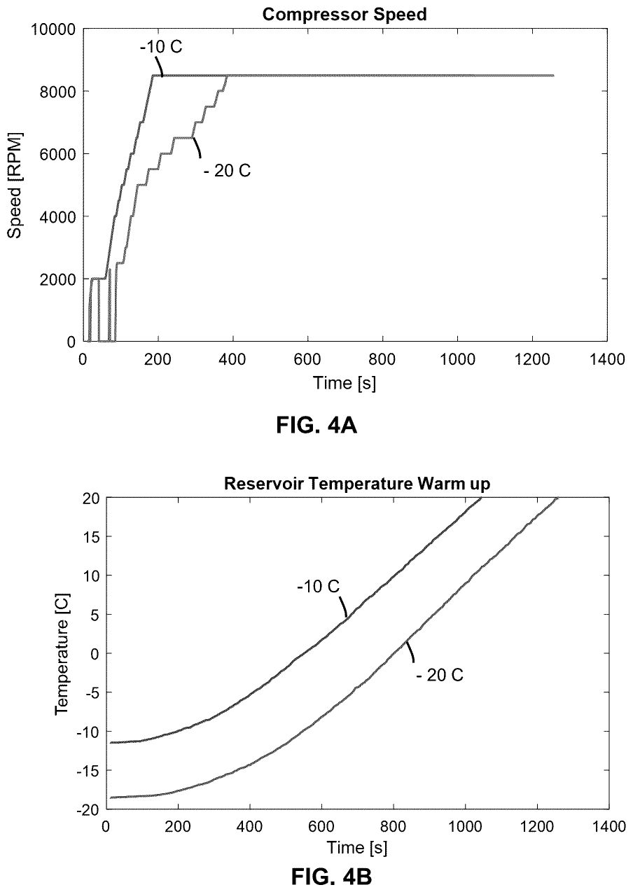

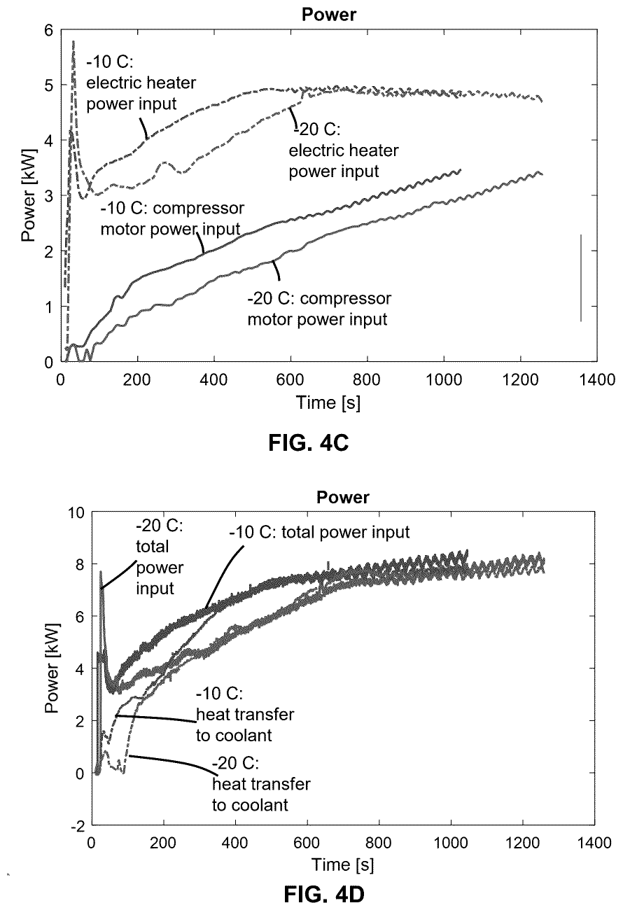

In an experimental example, the heating performance of an embodiment of a heat pump circuit 4 was tested using an embodiment of a system 40, in accordance with FIG. 3. The experiment was conducted in two successive trials with two different initial temperatures of about −10 and −20 degrees Celsius by cooling the first thermally insulated chamber 70 containing the heat pump circuit 4 to simulate the value of T_ambient at these initial temperatures, and by using the chiller 60 (while circulating the coolant through the second coolant loop 48) to reduce the temperature of the coolant in the coolant reservoir 42 to these initial temperatures to simulate the value of T_cabin at these initial temperatures. The use of the system 40 allowed each trial to be completed in about one hour, whereas conventional testing of an actual vehicle cabin 2 would take about 12 hours for the vehicle cabin 2 to reach the initial temperature. After the coolant has reached the desired initial temperature, electric power was supplied to the electric compressor motor 8 under control of the compressor controller 10 and to the electric heater 20 of the second heat exchanger 18 under control of the heater controller 22. The supplied electric power and the speed of the compressor motor 8 were monitored using the compressor controller 10; the electric power supplied to the electric heater 20 was monitored using the heater controller 22. Further, at the same time, the system 40 is activated so that first and second pumps 54, 62 convey the coolant through the first and second coolant loops 46, 48, respectively, while the chiller 60 is activated to cool the coolant in the second coolant loop 48. The temperature of the volume of coolant 44 in the coolant reservoir 42 was monitored using the temperature sensor 68. The compressor controller 10 and/or the heater controller 22 controlled the compressor motor 8 and/or the electric heater 20, respectively, based on the temperature of the coolant in the coolant reservoir 42, so as to reach the setpoint cabin temperature of +20 degrees Celsius. FIGS. 4A to 4D show the results of the experiment for both initial ambient temperatures of about −10 and −20 degrees Celsius, after activating the compressor motor 8 and the electric heater 20, and activating the system 40. FIG. 4A shows, over time, the speed of the compressor motor 8, and indicates that the compressor motor 8 is capable of running at full speed (about 8200 rpm) even at −20 degrees Celsius. FIG. 4B shows, over time, the temperature of the volume of coolant 44 in the coolant reservoir 42 (simulating the vehicle cabin 2), and indicates that the heat pump circuit 4 is capable of heating the volume of coolant 44 from the initial temperatures of about −10 degrees Celsius and −20 degrees Celsius to about +20 degrees Celsius in about 1030 seconds and about 1240 seconds, respectively. FIG. 4C shows, over time, the electric power input supplied to the compressor motor 8 and to the electric heater 20 of the second heat exchanger 18. FIG. 4D shows, over time, the total electric power input to the compressor motor 8 and the electric heater 20, in comparison with the heat power transferred to the volume of coolant 44 (which can be derived from the temperature data shown in FIG. 4B). FIG. 4D, in conjunction with FIG. 4B, shows that about 8 KW of power is sufficient to heat the volume of coolant 44 to a temperature of about +20 degrees Celsius. FIG. 4D can be integrated to determine the total electric energy input to the compressor motor 8 and the electric heater 20 and the total heat energy transferred to the volume of coolant 44. The total heat energy transferred to the volume of coolant 44 can be compared to the total electric energy input to determine the energy efficiency (or coefficient of performance (COP)) of the heat pump circuit 4.

In the foregoing example, it was assumed that the heat loss rate, W, for the simulated vehicle cabin 2 is a constant value, determined using the setpoint temperature of the vehicle cabin 2 of +20 degrees Celsius for each trial. This allowed for the determination of a constant flow rate, Q, of the coolant through the second coolant loop 8 during the trial. In actuality, however, the simulated temperature, T_cabin, of the vehicle cabin 2 may change during the trial. Since the heat loss rate, W, for the simulated vehicle cabin 2 depends on the temperature differential (T_cabin−T_ambient) (see FIG. 2B for example), this means that the heat loss rate, W, may also change during the trial. For instance, when T_cabin and T_ambient are both initially at −20 degrees Celsius, the heat loss rate, W, is zero, but then increases as T_cabin increases above T_ambient. Therefore, the following approach may be taken to dynamically change the flow rate Q during the trial. The memory (i.e. a non-transitory computer readable medium) of a controller associated with the second coolant loop (e.g., the pump controller 63 and/or the valve controller 67) may store one or more predetermined relationship(s), such as the relationships shown in FIGS. 2A and 2B. For example, the relationship(s) may be stored in the memory as a quantitative relationship in the form of a mathematical function or a lookup table. The temperature sensor 68 may be used to periodically measure the temperature of the volume of coolant 44 in the coolant reservoir 42 or other location in the second coolant loop 48. Based on the relationship(s) stored in the memory and the prevailing measured temperature of the volume of coolant 44, and in accordance with instructions stored in the memory, a processor of the controller (e.g., the pump controller 63 and/or the valve controller 67) may periodically determine the corresponding heat loss rate, W, and the flow rate Q of coolant in the second coolant loop 48 required to simulate the heat loss rate W. In accordance with the instructions stored in the memory, the processor of the controller then generates a signal to periodically control, in real-time, the second pump 62 and/or the at least one valve 66a, 66b to control the flow rate of coolant in the second coolant loop 48 in accordance with the determined flow rate Q. By use of a controller in this manner, the testing of the heat pump circuit 4 may be partially or wholly automated to conduct a series of trials for different combination of values of T_cabin and T_ambient, and different operating conditions of the vehicle (e.g., different vehicle speeds).

### System for Simulating Vehicle Cabin for Testing a Heat Pump Circuit for Cooling a Vehicle Cabin

As previously noted, a heat pump circuit can be used to provide cooling duty to a fluid flowing through a fluid flow path of the heat exchanger—i.e., the heat pump circuit is used as an air conditioner. Further, the temperature, T_ambient, of the ambient environment surrounding the vehicle cabin may be at a temperature that is greater than the temperature of the air, T_cabin, in the vehicle cabin 2 that is conditioned by the heat pump circuit.

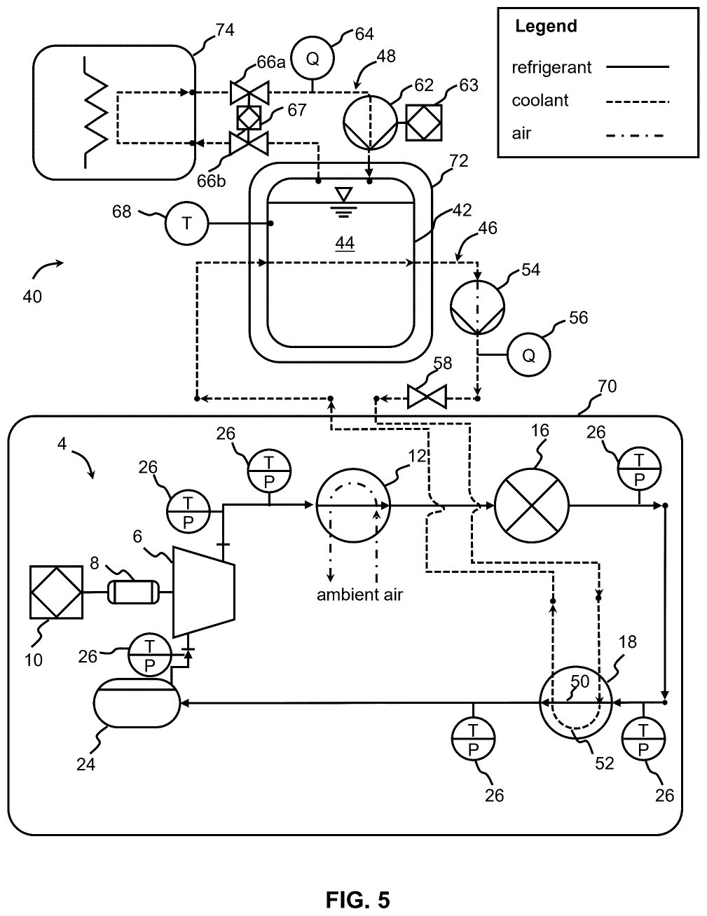

FIG. 5 shows another embodiment of a system 40 for simulating a vehicle cabin 2 for testing a heat pump circuit 4 that is used for cooling the vehicle cabin 2. The heat pump circuit 4 is similar to that shown in FIGS. 1 and 2, with like reference numerals used to denote analogous components. In the embodiment shown in FIG. 5, however, the first heat exchanger 12 acting as the condenser transfers heat from the refrigerant to ambient air. The second heat exchanger 18 acting as the evaporator is used to absorb heat from ambient air that subsequently flows to the vehicle cabin 2 to provide a cooling effect to the vehicle cabin 2. Accordingly, the refrigerant flow path 50 and the coolant flow path 52 are provided by the second heat exchanger 18, rather than by the first heat exchanger 12 as was the case in FIG. 3. Further, the second coolant loop 48 of the system 40 includes a heater 74 rather than a chiller 60 as was the case in FIG. 3. In use and operation of the system 40, the flow of coolant through the through the second coolant loop 48 is used to simulate heat gain from the ambient air in the vehicle cabin 2. Thus, the speed of the second pump 62 and/or the opening size of the at least one valve (in this embodiment, the pair of valves 66a, 66b) may be selected to effect a flow rate of the coolant through the heater 74 such that a heat gain rate due to heating of the coolant by the heater 74 is equivalent to a predetermined heat gain rate of the vehicle cabin 2, such as when situated in an ambient environment at a relatively higher temperature, T_ambient. It will be understood that the use and operation of the system 40 for simulating a vehicle cabin 2 for testing a heat pump circuit 4 that is used for cooling the vehicle cabin 2 is analogous to the use and operation of the system for testing a heat pump circuit 4 that is used for heating the vehicle cabin 2, as described above. To summarize, a heat gain rate, W, is determined for particular values of T_cabin (e.g., +20 degrees Celsius) and T_ambient (e.g., +30 degrees Celsius). A flow rate, Q, of the coolant through the second coolant loop 42 is determined based on the determined heat gain rate, W, to simulate the determined heat gain rate. The heater 74 may be activated while circulating coolant through the second coolant loop 48 to raise the temperature of the coolant in the coolant reservoir 44 to the initial temperature, T_ambient. The interior of the thermally insulated chambers 70, 72 may be heated so that the environment surrounding the heat pump circuit 4 and the coolant reservoir 42 is at temperature, T_ambient, of an ambient environment to be simulated. For example, the interior of the thermally insulated chambers 70, 72 may be heated to a temperature of +30 degrees Celsius to simulate summer conditions. Rather than the second coolant loop 48 using the chiller 60 to simulate heat loss from the cabin (see FIG. 3), the second coolant loop 48 uses the heater 74 (see FIG. 5) to simulate heat gain to the vehicle cabin 2.

While the description contained herein constitutes a plurality of embodiments of the present invention, it will be appreciated that the present invention is susceptible to further modification and change without departing from the fair meaning of the accompanying claims.

What is claimed is:

1. A method for simulating a vehicle cabin heated or cooled by a heat pump circuit, wherein the vehicle cabin has a predetermined thermal mass and a predetermined heat loss rate or heat loss rate, wherein the heat pump circuit comprises a refrigerant loop comprising a refrigerant flow path through a heat exchanger, the method comprising:
storing a volume of coolant in a coolant reservoir for simulating the vehicle cabin, wherein a thermal mass of the volume of coolant is equivalent to the predetermined thermal mass of the vehicle cabin;
circulating a refrigerant through the refrigerant loop and simultaneously circulating the coolant through:
a first coolant loop to simulate heating or cooling of the vehicle cabin, and comprising the coolant reservoir and a coolant flow path of the heat exchanger in thermal communication with the refrigerant flow path through the heat exchanger, whereupon heat is transferred via the heat exchanger either from the refrigerant to the coolant or from the coolant to the refrigerant; and
a second coolant loop to simulate heat loss from the vehicle cabin or heat gain to the vehicle cabin, and comprising the coolant reservoir and one of a chiller that cools the coolant to simulate heat loss from the vehicle cabin and a heater that heats the coolant to simulate heat gain to the vehicle cabin, wherein the second coolant loop is exclusive of the first coolant loop except for the coolant reservoir; and
controlling a flow rate of the coolant through the second coolant loop such that a heat loss rate of the coolant due to cooling of the coolant by the chiller is equivalent to the predetermined heat loss rate of the vehicle cabin or such that a heat gain rate of the coolant due to heating by the heater is equivalent to the predetermined heat gain rate of the vehicle cabin.

2. The method of claim 1, wherein:
the method is for simulating the vehicle cabin heated by the heat pump circuit;
the second coolant loop comprises the chiller that cools the coolant to simulate heat loss from the vehicle cabin; and
controlling the flow rate of the coolant through the second coolant loop is performed such that the heat loss rate of the coolant due to cooling of the coolant by the chiller is equivalent to the predetermined heat loss rate of the vehicle cabin.

3. The method of claim 1, wherein:
the method is for simulating the vehicle cabin cooled by the heat pump circuit;
the second coolant loop comprises the heater that heats the coolant to simulate heat gain to the vehicle cabin; and
controlling the flow rate of the coolant through the second coolant loop is performed such that the heat gain rate of the coolant due to heating of the coolant by the heater is equivalent to the predetermined heat gain rate of the vehicle cabin.

4. The method of claim 1, wherein controlling the flow rate of the coolant through the second coolant loop comprises controlling a pump for conveying the coolant through the second coolant loop.

5. The method of claim 1, wherein controlling the flow rate of the coolant through the second coolant loop comprises controlling a valve in the second coolant loop.

6. The method of claim 1, wherein:
at least one non-transitory computer-readable medium stores the predetermined heat loss rate or heat gain rate or at least one relationship that prescribes the predetermined heat loss rate or heat gain rate; and
at least one processor operatively connected to the at least one non-transitory computer readable medium is used for controlling of the flow rate of the coolant through the second coolant loop by controlling a pump for conveying the coolant through the second coolant loop and/or a valve in the second coolant loop, based on the predetermined heat loss rate or heat gain rate or the at least one relationship that prescribes the predetermined heat loss rate or heat gain rate stored by the at least one non-transitory computer-readable medium.

7. The method of claim 6, wherein the method further comprises:
measuring a temperature of the coolant in the second coolant loop; and
using the at least one processor, determining the predetermined heat loss rate or heat gain rate based on the at least one relationship that prescribes the predetermined heat loss rate or heat gain rate stored in the at least one non-transitory computer readable medium and based on the measured temperature of the coolant in the second coolant loop.

8. The method of claim 1, further comprising, before circulating the refrigerant through the refrigerant loop and simultaneously circulating the coolant through the first coolant loop and the second coolant loop, using the cooler or the heater to regulate a temperature of the coolant in the coolant reservoir to an ambient temperature of an environment surrounding the vehicle cabin to be simulated.

9. A system for simulating a vehicle cabin heated or cooled by a heat pump circuit, wherein the vehicle cabin has a predetermined thermal mass and a predetermined heat loss rate or heat gain rate, wherein the heat pump circuit comprises a refrigerant loop comprising a refrigerant flow path of a heat exchanger, the system comprising:
a coolant reservoir storing a volume of coolant having a thermal mass equivalent to the predetermined thermal mass of the vehicle cabin;
a first coolant loop for simulating heating or cooling of the vehicle cabin, and comprising the coolant reservoir, a coolant flow path of the heat exchanger in thermal communication with the refrigerant flow path of the heat exchanger, and a first pump for conveying the coolant through the first coolant loop; and
a second coolant loop for simulating heat loss from the vehicle cabin or heat gain to the vehicle cabin, and comprising the coolant reservoir, one of a chiller for cooling the coolant and a heater for heating the coolant, and a second pump for conveying the coolant through the second coolant loop, wherein the second coolant loop is exclusive of the first coolant loop except for the coolant reservoir;
wherein the first pump and the second pump are operable simultaneously to convey coolant simultaneously through the first coolant loop and the second loop; and
wherein the second pump is operable to convey the coolant at a flow rate through the second coolant loop such that a heat loss rate of the coolant due to cooling of the coolant by the chiller is equivalent to the predetermined heat loss rate of the vehicle cabin or such that a heat gain rate of the coolant due to heating by the heater is equivalent to the predetermined heat gain rate of the vehicle cabin.

10. The system of claim 9, wherein:
the system is for simulating the vehicle cabin to be heated by the heat pump circuit;
the second coolant loop comprises the chiller that cools the coolant to simulate heat loss from the vehicle cabin; and
the second pump in the second coolant loop is operable to convey the coolant at the flow rate through the second coolant loop such that the heat loss rate of the coolant due to cooling of the coolant by the chiller is equivalent to the predetermined heat loss rate of the vehicle cabin.

11. The system of claim 9, wherein:
the system is for simulating the vehicle cabin to be cooled by the heat pump circuit;
the second coolant loop comprises the heater that heats the coolant to simulate heat gain to the vehicle cabin; and
the second pump is operable to convey the coolant at the flow rate through the second coolant loop such that the heat gain rate of the coolant due to heating of the coolant by the heater is equivalent to the predetermined heat gain rate of the vehicle cabin.

12. The system of claim 9, wherein the system further comprises a valve in the second coolant loop that is operable to control the flow rate of the coolant through the second coolant loop.

13. The system of claim 9, wherein the system further comprises:
at least one non-transitory computer-readable medium storing the predetermined heat loss rate or heat gain rate or at least one relationship that prescribes the predetermined heat loss rate or heat gain rate; and
at least one processor operatively connected to the at least one non-transitory computer readable medium and configured by instructions stored on the at least one non-transitory computer readable medium to control the flow rate of the coolant through the second coolant loop by controlling the second pump and/or a valve in the second coolant loop, based on the predetermined heat loss rate or heat gain rate or the at least one relationship that prescribes the predetermined heat loss rate or heat gain rate stored by the at least one non-transitory computer-readable medium.

14. The system of claim 13:
wherein the system further comprises a temperature sensor for measuring a temperature of the coolant in the second coolant loop; and
wherein the processor is configured by the instructions stored on the at least one non-transitory computer readable medium to determine the predetermined heat loss rate or heat gain rate based on the at least one relationship that prescribes the predetermined heat loss rate or heat gain rate stored by the at least one non-transitory computer-readable medium and based on the temperature of the coolant in the second coolant loop measured by the temperature sensor.

15. The system of claim 9, further comprising a thermally insulated chamber, wherein the coolant reservoir is disposed inside the thermally insulated chamber.
